(19) United States
(12) Patent Application Publication
(10) Pub. No.: US 2015/0074969 A1
(43) Pub. Date: Mar. 19, 2015

(54) INTEGRATED PASSENGER AIRBAG

(71) Applicant: Ford Global Technologies, LLC, Dearborn, MI (US)

(72) Inventors: Pardeep Kumar Jindal, Canton, MI (US); Rahul Makwana, Dearborn Heights, MI (US)

(73) Assignee: Ford Global Technologies, LLC, Dearborn, MI (US)

(21) Appl. No.: 14/028,828

(22) Filed: Sep. 17, 2013

(51) Int. Cl. B60R 21/233; B60R 21/205

(52) U.S. Cl. CPC B60R 21/233; B60R 21/205; B60R 2021/0004
USPC 29/428; 280/729

(57) ABSTRACT

An integrated airbag in the inflated condition has a main airbag portion defining an upper chamber and a lower extended portion defining a chamber depending from the main airbag portion. The main airbag portion in the inflated condition acts against the head and torso of the occupant so as to generate a restraining force against the occupant, and the lower extended portion in the inflated condition acts against the pair of knees of the occupant so as to mitigate the femur forces on the knees of the motor vehicle occupant generated by contact with the lower portion of the instrument panel during the impact.

### FIELD OF THE INVENTION

The present invention generally relates to an airbag for a motor vehicle to optimize occupant protection during a frontal impact event, specifically an integrated airbag mounted in the instrument panel that is triggered to inflate in the event of and to mitigate frontal impacts to restrain the torso, head, and lower extremities of a motor vehicle passenger.

### BACKGROUND OF THE INVENTION

Improving the crashworthiness of motor vehicles has long been the goal of automobile manufacturers and policymakers. In the United States, Federal Motor Vehicle Safety Standard (FMVSS) No. 208 was promulgated to encourage improved occupant responses to frontal impact events. In sum, FMVSS 208 presently requires that a simulated vehicle occupant experience head and thoracic de-accelerations and right and left femur loads within specified limits following a motor vehicle impact with a rigid barrier at an impact velocity of 35 MPH. Additionally, the National Highway and Traffic Administration conducts its New Car Assessment Program (NCAP), which reports the results of its testing to the public based on the testing conducted according to the procedures of FMVSS 208.

In view of such testing protocols, front end structures have been optimized to meet frontal safety requirements in such frontal impact events. That is, techniques have been adopted to absorb the kinetic energy from such frontal impacts and reduce the severity of the secondary impact that potentially occurs between the motor vehicle occupant and the interior components of the passenger compartment. In addition to engineered structures for front end components, such as the engine compartment, hood, fenders, and front wheel suspension and undercarriage components, occupant restraints have been employed. Such occupant restraint systems, particularly for front passengers, include adaptive seatbelts, energy absorbing glove boxes, and airbag systems.

Airbag systems for use in motor vehicles are generally well-known in the art.

Traditionally, such airbag systems have been used within motor vehicle interiors to mitigate and reduce occupant impacts with motor vehicle interior components and structures, such as steering wheels, instrument panels, knee bolsters, glove boxes, side door panels, and body pillars. Such airbag systems are designed to deploy very quickly upon detection of the impact event, depending on its severity.

In the adoption of frontal impact airbags, however, it is sometimes necessary to utilize two separate airbags to restrain the motor vehicle occupant to obtain optimal test results within the specified criteria. In particular, in the case of a front seat passenger position, a first passenger airbag is often mounted in an upper portion of the instrument panel and, when inflated, engages the torso and head of the passenger. A separate second knee airbag may be mounted in a lower portion of the instrument panel and, when inflated, engages the lower extremities, in particular, the knees of the passenger, to reduce loading on the occupant's femurs. However, the use of a separate knee airbag incurs additional cost, complexity, and weight. For example, additional structural steel is required to attach the knee airbag to the instrument panel and provide appropriate reinforcement. Hence, solutions for obtaining acceptable simulated occupant responses, particularly femur loads, without use of a separate knee airbag would be advantageous.

The airbag assembly disclosed herein particularly accomplishes the foregoing optimization of simulated occupant response to a frontal impact event by providing an integrated airbag mounted on the upper portion of the instrument panel. The integrated airbag in the inflated condition has a main airbag portion defining an upper chamber and a lower extended portion defining a chamber depending from the main airbag portion. The main airbag portion in the inflated condition acts against the head and torso of the motor vehicle occupant so as to generate a restraining force against the head and torso of the motor vehicle occupant, and the lower extended portion in the inflated condition acts against the pair of knees of the motor vehicle occupant so as to mitigate femur forces on the knees of the motor vehicle occupant.

### SUMMARY OF THE INVENTION

According to one aspect of the present disclosure, an integrated airbag system is disclosed for mitigating motor vehicle occupant injuries in the event of a high speed impact of a motor vehicle with a frontal rigid barrier or other structure disposed in front of the motor vehicle. The motor vehicle includes an occupant compartment having a forward facing seat upon which an occupant is supported and a panel disposed in front of and facing the forward facing seat, wherein the panel has an upper portion and a lower portion. The airbag system includes an integrated airbag mounted on the panel, the integrated airbag having a stowed condition and an inflated condition. The integrated airbag in the inflated condition has a main airbag portion defining an upper chamber and a lower extended portion defining a chamber depending from the main airbag portion in fluid communication with the main airbag portion. An inflator is operationally coupled with the integrated airbag and is responsive to electrical actuation for inflating the integrated airbag with a gas. An impact detection sensor generates a signal upon an impact event, and a controller processes the signal generated by the detection sensor and electrically actuates the inflator upon computing a predetermined impact severity to the motor vehicle, wherein the main airbag portion in the inflated condition acts against the head and torso of the motor vehicle occupant so as to generate a restraining force against the motor vehicle occupant and the lower extended portion in the inflated condition acts against the pair of knees of the motor vehicle occupant so as to mitigate the femur forces on the knees of the motor vehicle occupant generated by contact with the lower portion of the panel during the impact event.

Still another aspect of the present disclosure is an airbag system wherein the forward facing seat is a front seat of the motor vehicle, the motor vehicle occupant is the front seat passenger, and the panel is the motor vehicle instrument panel.

Yet another aspect of the present disclosure is an airbag system wherein the occupant compartment includes a windshield disposed adjacent and above the instrument panel that in part defines an upper space amid the head and torso of the motor vehicle occupant, the windshield, and the instrument panel, wherein the main airbag portion in the inflated condition substantially fills the upper space amid the head and torso of the motor vehicle occupant, the windshield, and the instrument panel.

An additional aspect of the present disclosure is an airbag system wherein the lower portion of the instrument panel in part defines a lower gap between the knees of the motor vehicle occupant and the instrument panel, wherein the lower extended portion in the inflated condition substantially fills the lower gap between the knees of the motor vehicle occupant and the lower portion of the instrument panel.

Another aspect of the present disclosure is an airbag system utilizing an integrated airbag mounted within a recess provided in the instrument panel.

Still another aspect of the present disclosure is an airbag system wherein the integrated airbag is mounted in the upper portion of the instrument panel.

A further aspect of the present disclosure is an airbag system wherein the femur loading on the motor vehicle occupant during the impact event is initially in tension, while subsequent femur loads are in compression.

Another aspect of the present disclosure is an airbag system wherein the lower extended portion is inflated subsequent to the inflation of the main airbag portion.

Yet a further aspect of the present disclosure is an airbag system wherein the main airbag portion defines a substantially spherical chamber, and the lower extended portion defines a substantially rectangular chamber.

An additional aspect of the present disclosure is an integrated airbag for mitigating occupant injuries in the event of a frontal impact comprising a main portion, a lower extended portion depending from the main portion, and an inflator mounted in a panel, wherein the main portion when inflated acts against the head and torso of the occupant, and the lower extended portion when inflated acts against the occupant's knees to mitigate the femur forces on the knees generated by contact with the panel during the impact.

Yet another aspect of the present disclosure is an airbag system wherein the main portion of the airbag defines a substantially spherical chamber, and the lower extended portion defines a substantially rectangular chamber depending from the main airbag portion.

A still further aspect of the present disclosure is a method of employing an airbag system to generate a resistive force against a motor vehicle occupant in the event of a high speed impact of a motor vehicle with a frontal rigid barrier or other structure disposed in front of the motor vehicle to restrain the motor vehicle occupant from impact with interior components of the motor vehicle is disclosed, as set forth above. The method includes the steps of providing an occupant compartment with a forward facing seat upon which an occupant is supported and an instrument panel disposed in front of and facing the front seat, wherein the instrument panel has an upper portion and a lower portion. The integrated airbag, when in the inflated condition, has a main airbag portion defining an upper chamber, and a lower extended portion defining a chamber depending from the main airbag portion. The impact detection sensor is mounted in the motor vehicle for generating a signal upon a frontal impact event proximate the front of the motor vehicle and providing the signal to a controller. An inflator is operationally coupled with the integrated airbag responsive to electrical actuation for inflating the integrated airbag with a gas when the controller computes a predetermined impact severity to the motor vehicle. The main airbag portion is inflated to act against the head and the torso of the motor vehicle occupant so as to generate a restraining force against the motor vehicle occupant, while the lower extended portion is inflated to act against the pair of knees of the motor vehicle occupant so as to mitigate the femur forces on the knees of the motor vehicle occupant generated by contact with the lower portion of the instrument panel during the impact event.

Another aspect of the present disclosure is a method of employing an airbag system wherein the lower extended portion is inflated subsequent to the inflation of the main portion.

A yet additional aspect of the present disclosure is a method of employing an airbag system wherein the main airbag portion defines a substantially spherical chamber, and the lower extended portion defines a substantially rectangular chamber.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a side view of the passenger airbag of the prior art in the inflated condition;

FIG. 2 is a side view of the passenger airbag and separate knee airbag of the prior art in the inflated condition;

FIG. 3 is a side view the integrated passenger airbag in the inflated condition in accordance with the present disclosure;

FIG. 4 is a perspective front view of the integrated passenger airbag in the inflated condition in accordance with the present disclosure;

FIG. 5 is a graphical representation comparing the expected right femur loads with no knee airbag provided, with a separate knee airbag provided, and with an integrated airbag in accordance with the present disclosure; and

FIG. 6 is a graphical representation comparing the expected left femur loads with no knee airbag provided, with a separate knee airbag provided, and with an integrated airbag in accordance with the present disclosure.

### DETAILED DESCRIPTION OF THE PREFERRED EMBODIMENTS

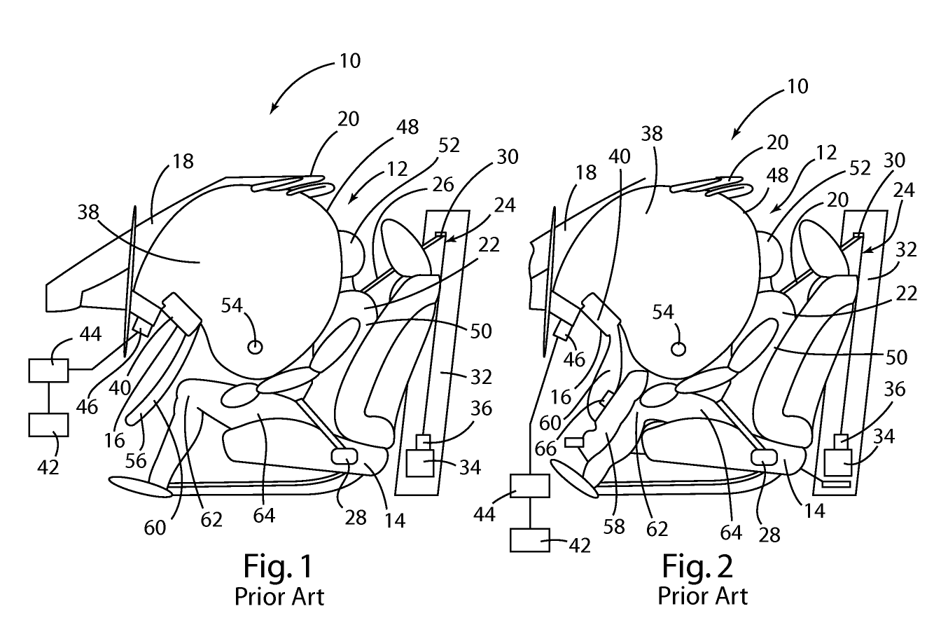

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to FIGS. 1-4, a motor vehicle 10 includes an interior occupant compartment 12 including a front seat assembly 14 and an instrument panel 16, the occupant compartment 12 being defined in part by a windshield 18 and a roof portion 20. The occupant 22, in particular a front seat passenger, is supported by the front seat assembly 14. The front seat assembly 14 is typically configured to move forward and rearward. The front seat occupant 22 is primarily restrained by a front passenger seat belt assembly 24 having a belt web 26, a lower detachable mount 28 attached to the inboard of the front seat assembly 14, an upper seat belt ring 30 on the so-called B-pillar 32 through which the belt web 26 passes, and a lower housing 34 within which a web reel and an inertial clutch assembly 36 is mounted that restrains the belt web 26 from further deploying in the event of a frontal crash event. However, it should be noted that the occupant 22 may be belted or unbelted and still obtain the benefits of the improvement of the present disclosure.

Additional occupant protection may be provided by a standard passenger airbag 38, without the improvement disclosed herein, as shown in FIG. 1. The passenger airbag 38 is mounted on the upper surface 40 of the instrument panel 16, proximate the windshield 18 and facing upwardly and toward the front seat occupant 22, and is disposed to actuate upon a frontal impact of a predetermined severity. That is, upon vehicle impact with a rigid barrier (not shown), a sensor 42 sends a signal to an electronic control unit 44 or ECU. Once the signal is processed, the ECU 44 actuates an inflator 46 operationally coupled with the front passenger airbag 38 to deploy the front passenger airbag 38. The passenger airbag 38, typically constructed from nylon or polyester, is configured such that the passenger airbag 38 will deploy in a substantially spherical configuration when in the inflated condition to substantially fill the space within the occupant compartment 12 below the windshield 18 proximate the instrument panel 16 and in front of the occupant 22, thereby creating a relatively compliant surface 48 against which the torso 50 and head 52 of the occupant 22 are restrained during an impact event.

However, while the passenger airbag 38 shown in FIG. 1 has proven to be extremely effective in obtaining compliance with the head and thoracic de-acceleration criteria in simulated vehicle occupant responses, such a passenger airbag 38 is not itself effective in mitigating the right and left femur loads within the specified limits following a motor vehicle impact with a rigid front barrier at an impact velocity of 35 MPH. For this purpose, energy absorbing knee bolsters 56 have been employed, as seen in FIG. 1.

Another solution for mitigating the right and left femur loads within the specified limits has been the adoption of a separate, second knee airbag 58 mounted in a lower portion 60 of the instrument panel 16 that, when inflated, engages the lower extremities, in particular, the knees 62 of the occupant 22, to reduce loading on the occupant's femurs 64, as shown in FIG. 2. However, the use of a separate knee airbag 58 incurs additional cost, complexity, and weight. For example, additional structural steel is required to attach the separate knee airbag 58 to the instrument panel 16 and to provide appropriate reinforcement. A separate knee airbag 58 also consumes valuable space within the instrument panel and requires separate sensor loops for the airbag electronics. That is, the use of a separate knee airbag 58 requires two inflators 46 and 66, one for the passenger airbag 38 and one for the knee airbag 58, in order to provide optimized protection for an occupant's torso 50, head 52, and lower extremities, such as knees 62 and femurs 64. Two airbags, two igniters, and duplicate related circuitry are required.

The integrated airbag 68 of the present disclosure provides an effective in-position airbag deployment solution to the airbag systems of the prior art. The disclosed integrated airbag 68, also constructed of nylon or polyester, is mounted in a recess 70 located on the upper portion 40 of the instrument panel 16 in the stowed condition. The integrated airbag 68 has a main airbag portion 72 when in the inflated condition. The main airbag portion 72 defines an upper chamber that substantially fills an upper space defined by the windshield 18 disposed adjacent and above the instrument panel 16. Preferably, the main airbag portion is substantially spherical, as shown, so as to efficiently fill the upper space. However, other shapes can be adopted, such as triangular, rectangular, elliptical, or trapezoidal. The main airbag portion 72 thus acts against the torso 50 and head 52 of the occupant 22 in the inflated condition so as to generate a restraining force against the occupant 22.

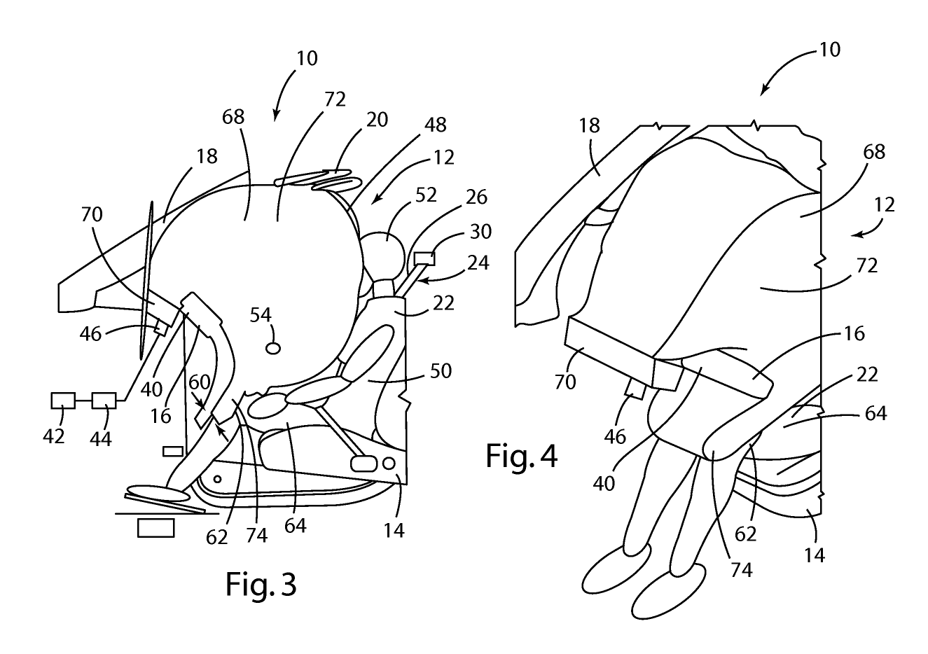

The integrated airbag 68 of the present disclosure also has a lower extended portion 74 defining a chamber depending from the main airbag portion 72 and in fluid communication with the main airbag portion 72, as shown in FIGS. 3 and 4. The lower portion 60 of the instrument panel 16 in part defines a lower gap G between the knees 62 of the motor vehicle occupant 22 and the lower portion 60 of the instrument panel 16, wherein the lower extended portion 74 in the inflated condition substantially fills the lower gap G between the knees 62 of the motor vehicle occupant 22 and the instrument panel 16. Preferably, the lower extending portion 74 is substantially rectangular, as shown. However, other shapes can be adopted, such as triangular, elliptical, or trapezoidal, so long as the gap G is filled.

The lower extended portion 74 thus acts against the pair of knees 62 of the motor vehicle occupant 22 in the inflated condition so as to reduce the femur forces on the knees of the knees 62 of the occupant 22 generated by contact with the lower portion 60 of the instrument panel 16 during an impact event. Preferably, the width of the lower extended portion 74 is sufficient to ensure contact with the lower extended portion 74 by both knees 62 of the occupant 22. Similarly, the depth of the lower extended portion 74 is preferably sufficient to ensure vertical contact with the lower extended portion 74 by the knees 62 of the 5^{th} percentile prototypical female occupant, the 50^{th} percentile prototypical male occupant, and the 95^{th} percentile prototypical large male occupant.

As above, an inflator 46 is operationally coupled with the integrated airbag 68 and is responsive to electrical actuation for inflating the integrated airbag 68 with a gas, such as sodium azide, when an impact detection sensor 42 generates a signal upon an impact event and directs the signal to a controller 44 for processing the signal generated by the detection sensor 42 upon computing a predetermined impact severity to the motor vehicle 10.

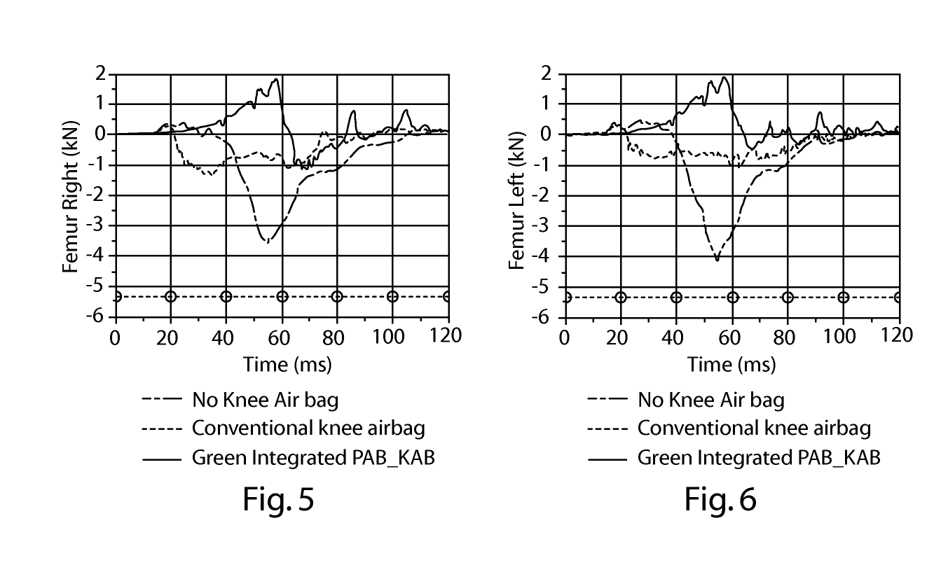

The disclosed integrated airbag 68 is believed to provide unique occupant protection for the lower extremities of the motor vehicle occupant 22. As shown in the simulations depicted in FIGS. 5-6, the peak femur 64 loads for the passenger airbag 38 acting against only the occupant's torso 50 and head 52 in combination with a knee bolster 56 is expected to be nearly three times higher than that of the passenger airbag 38 acting against the occupant's torso 50 and head 52 in combination with a separate knee airbag 58. In further comparison, due to the configuration of the integrated airbag 68 of the present disclosure, the lower extended portion 74 is inflated subsequent to the inflation of the main airbag portion 72. As a consequence, the torso 50 and head 52 of the occupant 22 are initially restrained, while the lower extremities of the occupant 22 tend to move forward due to inertia. Subsequently, the lower extended portion 74 is deployed and begins to act against the knees 62 of the occupant 22. Accordingly, the initial loading experienced by the occupant's femur 64 during an impact event is such that the initial femur 64 load is in tension and subsequent femur 64 loads are in compression, as shown in FIGS. 5-6, with the peak femur 64 loads comparing favorably with those experienced with the passenger airbag 38 acting against the occupant's torso 50 and head 52 in combination with a separate knee airbag 58, but without the cost and complexity associated with a separate knee airbag 58.

Thus, a cost-effective method of employing an airbag system to generate a resistive force against a motor vehicle occupant 22 in the event of a high speed impact of a motor vehicle 10 with a frontal rigid barrier or other structure disposed in front of the motor vehicle 10 to restrain the occupant 22 from impact with interior components of the motor vehicle 10 is disclosed, as set forth above. In operation, an integrated airbag 68 is provided within an occupant compartment 12 provided with a forward facing seat 14 upon which an occupant 22 is supported and an instrument panel 16 disposed in front of and facing the front seat 14, wherein the instrument panel 16 has an upper portion 40 and a lower portion 60. The integrated airbag 68 has a main airbag portion 72 preferably defining a substantially spherical chamber and a lower extended portion 74 preferably defining a substantially rectangular chamber depending from the main airbag portion 72. The impact detection sensor 42 mounted in the motor vehicle 10 generates a signal upon a frontal impact event proximate the front of the motor vehicle 10 and provides the signal to a controller 44. An inflator 46 is operationally coupled with the integrated airbag 68 responsive to electrical actuation for inflating the integrated airbag 68 with a gas when the controller 44 computes a predetermined impact severity to the motor vehicle 10. The main airbag portion 72 is inflated to act against the torso 50 and head 52 of the occupant 22 so as to generate a restraining force against the occupant 22, while the lower extended portion 74 is inflated to act against the pair of knees 62 of the occupant 22 so as to reduce the femur forces on the knees 62 of the occupant 22 generated from contact with the lower portion 60 of the instrument panel 16 during an impact event.

The integrated airbag 68 of the present disclosure provides uniform restraint to occupant's torso 50, head 52, and knees 62. In addition, the integrated airbag 68 has the advantage of using a single module to protect the occupant's torso 50, head 52, and lower extremities. The integrated frontal impact airbag system disclosed herein is lightweight, requires minimum packaging, and utilizes well-proven inflator technology. Further, the disclosed integrated frontal impact airbag system avoids the additional cost, complexity, and weight of a separate knee airbag. For example, the additional structural steel required to attach the separate knee airbag 58 to the instrument panel 16 and to provide appropriate reinforcement, as well as the duplicate sensor loops for the separate knee airbag 58, is completely avoided.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. An airbag system for mitigating motor vehicle occupant injuries in the event of a high speed impact of a motor vehicle with a frontal rigid barrier or other structure disposed in front of the motor vehicle, wherein the motor vehicle includes an occupant compartment having a forward facing seat upon which an occupant is supported and a panel disposed in front of and facing the forward facing seat, wherein the panel has an upper portion and a lower portion, the airbag system comprising:
an integrated airbag mounted on the panel, the airbag having a stowed condition and an inflated condition, wherein the integrated airbag has a main airbag portion defining an upper chamber in the inflated condition and a lower extended portion defining a chamber depending from the main airbag portion in the inflated condition in fluid communication with the main airbag portion;
an inflator operationally coupled with the integrated airbag responsive to electrical actuation for inflating the airbag with a gas;
an impact detection sensor for generating a signal upon an impact; and
a controller for processing the signal generated by the detection sensor and electrically actuating the inflator upon computing a predetermined impact severity to the motor vehicle, wherein the main airbag portion in the inflated condition acts against a head and a torso of the motor vehicle occupant so as to generate a restraining force against the motor vehicle occupant and the lower extended portion in the inflated condition acts against a pair of knees of the motor vehicle occupant so as to mitigate the femur forces on the knees of the motor vehicle occupant during the impact.

2. The airbag system of claim 1, wherein the forward facing seat is a front seat of the motor vehicle, the motor vehicle occupant is a front seat passenger, and the panel is the motor vehicle instrument panel.

3. The airbag system of claim 2, wherein the occupant compartment includes a windshield disposed adjacent and above the instrument panel that in part defines an upper space amid the head and torso of the motor vehicle occupant, the windshield, and the instrument panel, wherein the main airbag portion in the inflated condition substantially fills the upper space amid the head and torso of the motor vehicle occupant, the windshield, and the instrument panel.

4. The airbag system of claim 3, wherein the lower portion of the instrument panel in part defines a lower gap between the knees of the motor vehicle occupant and the instrument panel, wherein the lower extended portion in the inflated condition substantially fills the lower gap between the knees of the motor vehicle occupant and the instrument panel.

5. The airbag system of claim 2, wherein the integrated airbag is mounted within a recess provided in the instrument panel.

6. The airbag system of claim 5, wherein the integrated airbag is mounted in the upper portion of the instrument panel.

7. The airbag system of claim 1, wherein the motor vehicle occupant has a pair of femurs experiencing femur loading during the impact and wherein an initial femur load is in tension and subsequent femur loads are in compression.

8. The airbag system of claim 7, wherein the lower extended portion is inflated subsequent to the inflation of the main airbag portion.

9. The airbag system of claim 8, wherein the main airbag portion defines a substantially spherical chamber, and the lower extended portion defines a substantially rectangular chamber.

10. An integrated airbag for mitigating occupant injuries during a frontal impact comprising a main portion, a lower extending portion depending from the main portion, and an inflator mounted in a panel, wherein the main portion when inflated acts against a head and torso of the occupant, and the lower extending portion when inflated acts against a pair of knees of the occupant to mitigate femur forces on the knees during the impact.

11. The integrated airbag of claim 10, wherein the occupant is supported upon a forward facing seat and the panel is an instrument panel disposed in front of and facing the forward facing seat, wherein the instrument panel has an upper portion and a lower portion.

12. The integrated airbag of claim 11, wherein the main portion of the airbag defines a substantially spherical chamber and the lower extended portion defines a substantially rectangular chamber depending from the main airbag portion.

13. The integrated airbag of claim 12, wherein a windshield is disposed adjacent and above the instrument panel that in part defines an upper space amid a head and a torso of the occupant, the windshield, and the instrument panel, wherein the main airbag portion when inflated substantially fills the upper space amid the head and torso of the occupant, the windshield, and the instrument panel.

14. The integrated airbag of claim 13, wherein the lower portion of the instrument panel in part defines a lower gap between the knees of the motor vehicle occupant and the instrument panel, wherein the lower extended portion when inflated substantially fills the lower gap between a pair of knees of the occupant and the instrument panel.

15. The integrated airbag of claim 10, wherein the knee portion is inflated subsequent to the inflation of the main portion.

16. The integrated airbag of claim 15, wherein the main airbag portion defines a substantially spherical chamber and the lower extended portion defines a substantially rectangular chamber.

17. The integrated airbag of claim 10, wherein the occupant has a pair of femurs experiencing femur loading during the impact, and wherein an initial femur load is in tension and subsequent femur loads are in compression.

18. A method of employing an airbag system to generate a resistive force against a motor vehicle occupant in the event of a high speed impact of a motor vehicle with a frontal rigid barrier or other structure disposed in front of the motor vehicle to restrain the motor vehicle occupant from impact with interior components of the motor vehicle, wherein the method comprises the steps of:
providing an occupant compartment with a forward facing front seat upon which an occupant is supported and an instrument panel disposed in front of and facing the forward facing front seat, wherein the instrument panel has an upper portion and a lower portion;
mounting an integrated airbag on the upper portion of the panel, the airbag having a stowed condition and an inflated condition, wherein the integrated airbag in the inflated condition has a main airbag portion defining an upper chamber and a lower extended portion defining a chamber depending from the main airbag portion;
mounting an impact detection sensor for generating a signal upon a frontal impact proximate the front of the motor vehicle and providing the signal to a controller;
operationally coupling an inflator with the integrated airbag responsive to electrical actuation for inflating the integrated airbag with a gas when the controller computes a predetermined impact severity to the motor vehicle;
inflating the main airbag portion to act against a head and a torso of the occupant so as to generate a restraining force against the occupant; and
inflating the lower extended portion to act against the pair of knees of the motor vehicle occupant so as to mitigate femur forces on a pair of knees of the occupant during the impact.

19. The method of claim 18, wherein the lower extended portion is inflated subsequent to the inflation of the main portion.

20. The method of claim 18, wherein the main airbag portion is defines a substantially spherical chamber, and the lower extended portion defines a substantially rectangular chamber.
